(19) United States
(12) Patent Application Publication
(10) Pub. No.: US 2019/0217820 A1
(43) Pub. Date: Jul. 18, 2019

(54) Socket Assembly for a Ball Joint

(71) Applicant: Robert Bosch GmbH, Stuttgart (DE)

(72) Inventors: Sergio Del Valle Fresno, Barcelona (ES); Jens Ulrich, Buehl (DE); Darko Vuletic, Bogatic (RS); Christopher Wood, Canton, MI (US)

(21) Appl. No.: 16/334,415

(22) PCT Filed: Nov. 17, 2017
(86) PCT No.: PCT/EP2017/079587

§ 371 Date: Mar. 19, 2019

Related U.S. Application Data
(60) Provisional application No. 62/436,079, filed on Dec. 19, 2016.

(51) Int. Cl. B60S 1/24; F16C 11/06

(52) U.S. Cl. CPC B60S 1/24; F16C 2326/09; F16C 11/0695; F16C 11/0657

(57) ABSTRACT

A ball joint (28) includes a socket assembly (60) that provides a locking feature designed to work in combination with the ball stud to retain a rotatable connection between the ball stud (30) and the ball socket. The socket assembly includes a socket housing (62) and an elastic retaining member (82) that cooperate to prevent ball stud disengagement under operating loads. The socket housing includes a sidewall (65) that has an extended length relative to some conventional socket housings, and the elastic member is disposed in a circumferential groove formed in an outer surface of the ball socket at a location corresponding to the extended length.

### BACKGROUND

Vehicles typically have a windshield forward of the passenger compartment. A windshield wiper system is positioned adjacent the windshield, and includes wiper arms that support wiper blades. The wiper arms pivot over a predefined range of motion on pivot shafts so that the blades oscillate over the windshield to clear the windshield of moisture, dirt and/or debris. The pivot shaft is driven by a wiper actuating assembly that includes an actuator. The actuator may be connected to the pivot shaft by a linkage system that translates the rotation of the actuator shaft into oscillating motion of the wiper arms. The linkage includes one or more links that transfer force to the pivot shafts via a ball joint that includes a ball socket and a ball stud. The ball socket is mounted in an opening in one of the links, and the ball stud, mounted in an opening of another link, rotates within the ball socket. Wear of the ball socket over time can lead to disengagement of ball stud from the ball socket, which in turn may lead to loss of wiper system function. A need exists for a ball joint in which the ball stud is prevented from disengaging from the ball socket.

### SUMMARY

In some aspects, a socket assembly is configured to receive and retain a ball stud. The socket assembly includes a socket housing and an elastic retaining element. The socket housing includes a first end, a sidewall that surrounds a periphery of the first end, and a second end opposed to the first end. The second end is open and defined by a free edge of the sidewall. An inner surface of the sidewall has a spherical contour that has a center and is dimensioned to receive and retain a ball portion of a ball stud therein. An outer surface of the sidewall includes a circumferentially extending first groove that resides in a plane, and the plane is parallel to the first end and includes the center of the spherical contour, and a circumferentially extending second groove that is located between the plane and the second end. The second groove is parallel to the first groove, and the retaining element is disposed in the second groove.

The socket assembly may include one or more of the following features: The sidewall extends below the plane to an extent that a line passing through the center and intersecting the free edge of the sidewall forms an angle relative to the plane, and the angle is greater than 30 degrees. The socket housing includes a slit formed in the sidewall, and the slit passes through a thickness of the sidewall and opens at the second end. The slit extends in a direction perpendicular to the plane. The slit intersects the second groove. The retaining element is a C clip. The retaining element is a discontinuous flat washer.

In some aspects, a ball joint includes a socket assembly and a ball stud. The ball stud includes a cylindrical shank, and a ball portion disposed on one end of the shank. The ball portion includes a major diameter defined by a line that is perpendicular to a longitudinal axis of the shank and intersects the spherical element at a location of maximum diameter. The socket assembly is configured to receive and retain the ball portion. The socket assembly includes a socket housing and an elastic retaining element. The socket housing includes a first end, a sidewall that surrounds a periphery of the first end, and a second end opposed to the first end. The second end is open and defined by a free edge of the sidewall. An inner surface of the sidewall has a spherical contour that has a center and is dimensioned to receive and retain a ball portion of a ball stud therein. An outer surface of the sidewall includes a circumferentially extending first groove that resides in a plane, and the plane is parallel to the first end and includes the center of the spherical contour, and a circumferentially extending second groove that is located between the plane and the second end. The second groove is parallel to the first groove, and the retaining element is disposed in the second groove.

The ball joint may include one or more of the following features: The sidewall extends below the plane to an extent that a line passing through the center and intersecting the free edge of the sidewall forms an angle relative to the plane, and the angle is greater than 30 degrees. The socket housing includes a slit formed in the sidewall, and the slit passes through a thickness of the sidewall and opens at the second end. The slit extends in a direction perpendicular to the plane. The slit intersects the second groove. The retaining element is a C clip. The retaining element is a discontinuous flat washer.

In some aspects, a link assembly includes a link having a first end including a first opening. A socket assembly is disposed in the first opening. The socket assembly includes a socket housing and an elastic retaining element. The socket housing includes a first end, a sidewall that surrounds a periphery of the first end, and a second end opposed to the first end. The second end is open and defined by a free edge of the sidewall. An inner surface of the sidewall has a spherical contour that has a center and is dimensioned to receive and retain a ball portion of a ball stud therein. An outer surface of the sidewall includes a circumferentially extending first groove that resides in a plane, and the plane is parallel to the first end and includes the center of the spherical contour, and a circumferentially extending second groove that is located between the plane and the second end. The second groove is parallel to the first groove, and the retaining element is disposed in the second groove.

The link assembly may include one or more of the following features: The sidewall extends below the plane to an extent that a line passing through the center and intersecting the free edge of the sidewall forms an angle relative to the plane, and the angle is greater than 30 degrees. The socket housing includes a slit formed in the sidewall, and the slit passes through a thickness of the sidewall and opens at the second end. The slit extends in a direction perpendicular to the plane. The slit intersects the second groove. The retaining element is a C clip. The retaining element is a discontinuous flat washer.

In some aspects, a wiper actuating assembly is configured to actuate a wiper arm. The wiper actuating assembly includes an actuator and a linkage that connects the actuator to the wiper arm. The linkage includes a link having a first end including a first opening. A socket assembly is disposed in the first opening. The socket assembly comprising a socket housing and a retaining element. The socket housing includes a first end, a sidewall that surrounds a periphery of the first end, and a second end opposed to the first end. The second end is open and defined by a free edge of the sidewall. An inner surface of the sidewall has a spherical contour that has a center and is dimensioned to receive and retain a ball portion of a ball stud therein. An outer surface of the sidewall includes a circumferentially extending first groove that resides in a plane, and the plane is parallel to the first end and includes the center of the spherical contour, and a circumferentially extending second groove that is located between the plane and the second end. The second groove is parallel to the first groove, and the retaining element is disposed in the second groove.

The wiper actuating assembly may include one or more of the following features: The sidewall extends below the plane to an extent that a line passing through the center and intersecting the free edge of the sidewall forms an angle relative to the plane, and the angle is greater than 30 degrees. The socket housing includes a slit formed in the sidewall, and the slit passes through a thickness of the sidewall and opens at the second end. The slit extends in a direction perpendicular to the plane. The slit intersects the second groove. The retaining element is a C clip. The retaining element is a discontinuous flat washer.

In some aspects, a ball joint includes a socket assembly that provides a locking feature designed to work in combination with the ball stud to retain a rotatable connection between the ball stud and the ball socket. The socket assembly includes a socket housing and an elastic retaining member that cooperate to prevent ball stud disengagement under operating loads. The socket housing includes a sidewall that has an extended length relative to some conventional socket housings, and the elastic member is disposed in a circumferential groove formed in an outer surface of the ball socket sidewall at a location corresponding to the extended length. The retaining member may be assembled with the ball socket prior to assembly with the ball stud, or may be assembled with the ball socket after the ball stud is assembled with the ball socket. The elastic retaining member may be, for example, a C clip, a spring, a cotter-pin or other appropriate fastener.

### BRIEF DESCRIPTION OF THE DRAWINGS

FIG. 1 is a top view of a vehicle wiper actuating assembly including a linkage that connects an actuator to a wiper arm (the wiper arm is not shown).

FIG. 2 is a top view of the linkage of FIG. 1 including links that are interconnected using ball joints.

FIG. 3 is a side view of a ball joint including a ball stud engaged with a ball socket.

FIG. 4 is a side cross-sectional view of the ball joint of FIG. 3.

FIG. 5 is a perspective view of the ball joint of FIG. 3 illustrating the ball socket disposed at an angle relative to a longitudinal axis of the stem of the ball stud.

FIG. 6 is a side cross-sectional view of the ball joint of FIG. 5.

### DETAILED DESCRIPTION

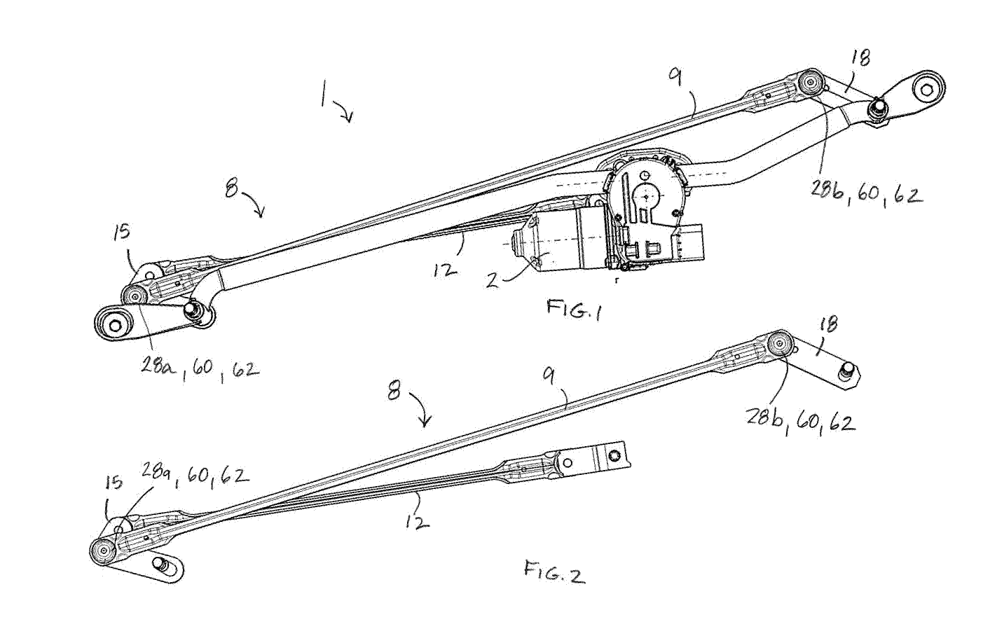

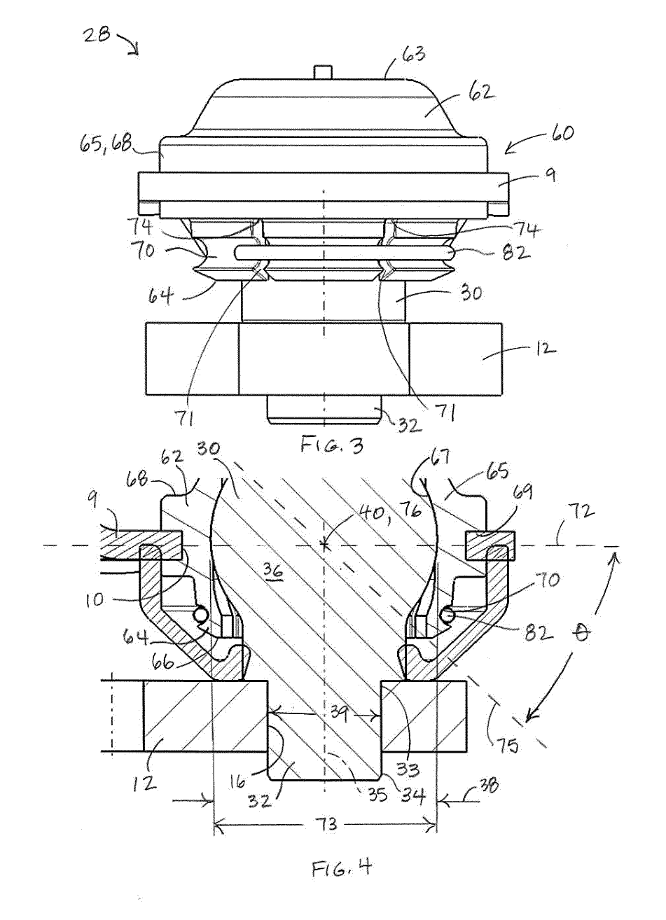

Referring to FIGS. 1-4, a vehicle wiper actuating assembly 1 is used to wipe a pair of wiper blades (not shown) over a vehicle windshield (not shown) to clear the windshield of moisture, dirt and/or debris. The wiper actuating assembly 1 includes an actuator 2 and a multi-bar linkage 8 that connects the actuator 2 to wiper arms (not shown), each wiper arm supporting a wiper blade. The wiper arms are supported relative to the vehicle on a pivot shaft (not shown), and the wiper arms are rotated about the pivot shaft by the wiper actuating assembly 1 via the linkage 8. In the illustrated embodiment, the linkage 8 includes four links 9, 12, 15, 18 that are interconnected by ball joints 28. For example, a first end of a first link 9 is connected to a first pivot plate 15 via a first ball joint 28a, and a second end of the first link 9 is connected to a second pivot plate 18 via a second ball joint 28b. The ball joints 28a, 28b each include a socket assembly 60 and a ball stud 30. Both ends of the first link 9 include a link opening 10, and a socket assembly 60 is fixed within the link opening 10. Likewise, an end of each pivot plate 15, 18 includes a pivot plate opening 16, and a shank 32 of the ball stud 30 is fixed within the pivot plate opening 16. The socket assembly 60 is configured to receive the ball portion 36 of the ball stud 30, and retain the ball portion 36 therewithin, as discussed in detail below.

The ball stud 30 includes the cylindrical shank 32, and the ball portion 36 disposed on a first end 33 of the shank 32. The shank 32 has a second end 34 that is spaced apart from the first end 33, and a longitudinal axis 35 that extends between the shank first and second ends 33, 34. The ball portion 36 is a spherical element that includes a major diameter 38 that is larger than a diameter 39 of the shank 32. The major diameter 38 of the ball portion 36 corresponds to a straight line that is perpendicular to the longitudinal axis 35 of the shank, passes through a center 40 of the ball portion 36 and meets the outer surface of the ball portion 36 at each end.

The socket assembly 60 includes a socket housing 62 and an elastic retaining element 82 that surrounds a portion of the socket housing 62 and serves as a secondary retention feature for retaining the ball portion 36 within the socket housing 62 regardless of the wear condition of the socket housing 62, as discussed further below.

The socket housing 62 is a dome-shaped structure that includes a generally cylindrical sidewall 65 and has a closed first end 63. The socket housing 62 includes a second end 64 that is opposed to the first end 63. The second end 64 is open and is defined by a free edge 66 of the sidewall 65. An inner surface 67 of the sidewall 65 has a spherical contour that is dimensioned to receive and retain the ball portion 36 of the ball stud 30 therein. In particular, the inner surface 67 is shaped and dimensioned to correspond to the shape and dimensions of the ball stud ball portion 36, and provides a primary retention feature for retaining the ball portion 36 within the socket housing 62 regardless of the wear condition of the socket housing 62. Like the ball portion 36, the socket housing inner surface 67 defines a major diameter 73. The socket housing major diameter 73 passes through the center 76 of the spherical contour defined by the socket housing inner surface 67 and extends in parallel to the socket housing first and second ends 63, 64.

The sidewall outer surface 68 is formed having a first groove 69 that extends about a circumference of the socket housing 62. The first groove 69 resides in a plane 72 that is parallel to the first end 63 and is disposed at a longitudinal location that corresponds to the socket housing major diameter 73. The first groove 69 has a cross section that is shaped and dimensioned to correspond to the cross-sectional shape and dimensions of the link opening 10. In the illustrated embodiment for example, the first groove 69 has a generally rectangular cross sectional shape. In use, the first groove 69 receives and engages the edge of the opening 10 in the first link 9, whereby the socket housing 62 is fixed to the first link 9.

In some embodiments, the socket housing 62 is a plastic element that is insert molded onto the end of the link 9 and within the opening 10 so that the edge of the link 9 that defines the opening 10 is received within the first circumferential groove 69.

The sidewall outer surface 68 is formed having a second groove 70 that is configured to receive and retain the retaining element 82 therein. The second groove 70 extends about a circumference of the socket housing 62, and is located between the plane 72 and the socket housing second end 64. The second groove 70 is parallel to the first groove 69. The second groove 70 has a cross section that is shaped and dimensioned to correspond to the cross-sectional shape and dimensions of the retaining element 82. In the illustrated embodiment for example, the second groove 70 has a generally circular cross sectional shape.

To accommodate formation of the second groove 70 at a location between the plane 72 and the socket housing second end 64, the socket housing 62 is formed having a sidewall 65 that has an extended length relative to some conventional socket housings such that it overlies the ball portion 36 at a location adjacent to the shank first end 33. That is, the sidewall 65 extends below the plane 72 to an extent that a line 75 passing through the center 76 of the spherical contour and intersecting the sidewall free edge 66 forms an angle θ relative to the plane 72. In the illustrated embodiment, the angle θ is greater than 30 degrees. However, the angle θ of may be greater or less depending on the size and shape of the socket housing, retaining element, etc. This can be compared to some conventional socket housings in which a line passing through the center of the spherical contour and intersecting the sidewall free edge forms an angle of about 25 degrees.

The socket housing sidewall 65 may be provided with at least one a slit 71 that passes through a thickness of the sidewall 65. In the illustrated embodiment, for example, the sidewall 65 includes six slits 71 that are equidistantly spaced about a circumference of the socket housing second end 64. The slits 71 open at the socket housing second end 64 and extend in a direction perpendicular to the plane 72 and toward the socket housing first end 63. The slits 71 terminate in a blind end disposed between the first and second grooves 60, 70. By this arrangement, each slit 71 intersects the second groove 70. The slits 71 allow the socket housing second end 64 to expand outward during insertion of the ball portion 36 into the socket housing 62 via the housing second end 64.

The retaining element 82 is an annular elastic member having discontinuity along its circumference so as to have a C shape when viewed in top plan view. The discontinuity extends along an arc that may for example correspond to an angle in a range of 20 degrees to 30 degrees. In some embodiments, the retaining element 82 is a C-clip having circular cross sectional shape or a square cross sectional shape. In some embodiments requiring a relatively higher retaining force, the retaining element 82 may be a discontinuous flat washer having a rectangular cross-sectional shape.

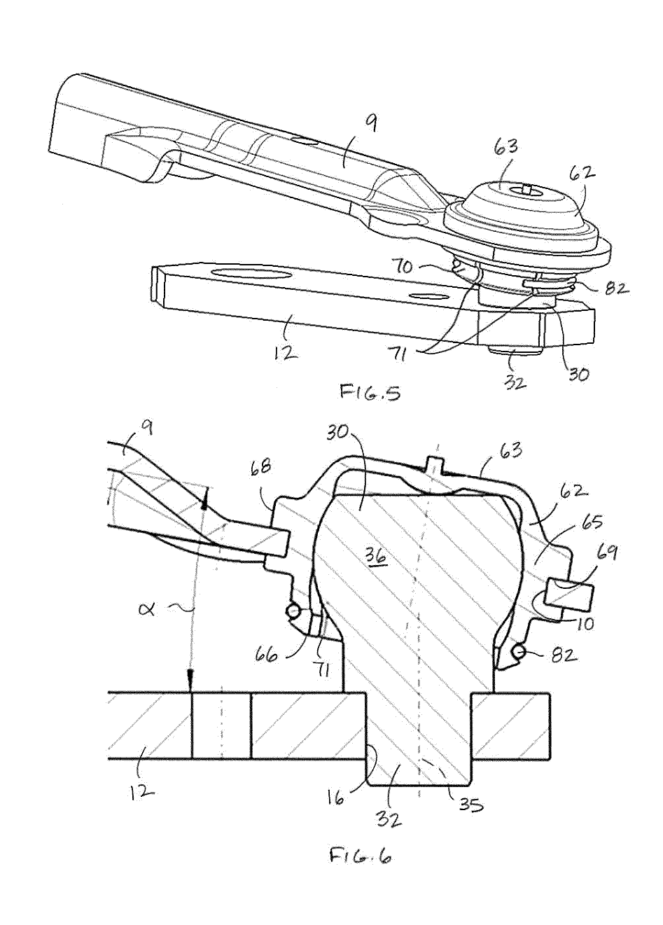

Referring also to FIGS. 5 and 6, the retaining element 82 is disposed in the second groove 70 and surrounds a portion of the socket housing 62. The retaining element 82 is sufficiently stiff to provide a retaining force that retains the ball portion 36 within the socket housing 62 during operation of the vehicle wiper actuating assembly 1, regardless of wear of the socket housing 62. In addition, the retaining element 82 is sufficiently stiff to provide a retaining force that retains the ball portion 36 within the socket housing 62 for an angular displacement a of the socket housing 62 relative to the ball stud 30 in a range of about 0 degrees to about 15 degrees. For example, in the embodiment illustrated in FIGS. 5 and 6, the angle α is 10 degrees.

In some embodiments in which the retaining element 82 is assembled with the socket housing 62 prior to assembly with the ball stud 30, the retaining element 82 is also sufficiently elastic to permit insertion of the ball stud 30 into the socket housing 62.

In the illustrated embodiment, the socket housing sidewall 65 has six equidistantly-spaced slits 71 that pass through a thickness of the sidewall 65. It is understood, however, that the socket housing is not limited to this configuration. For example, the sidewall 65 may be formed with a greater or fewer number of slits, or with no slits at all, as required by the specific application. In another example, the sidewall may be formed having irregularly spaced and/or sized slits, as required by the specific application.

In the illustrated embodiment, the socket housing 62 of the socket assembly 60 is described as having a closed first end 63 and a second end 64 is that is open. However, the socket housing is not limited to this configuration. For example, in some embodiments, both the first end and the second end may be open, allowing the socket assembly including the retaining element to be used with a double ball stud such as found in wiper systems with motor cranks having double ball studs.

Selective illustrative embodiments of the ball joint for the vehicle wiper actuating assembly are described above in some detail. It should be understood that only structures considered necessary for clarifying the ball joint have been described herein. Other conventional structures, and those of ancillary and auxiliary components of the ball joint and the vehicle wiper actuating assembly, are assumed to be known and understood by those skilled in the art. Moreover, while a working example of the vehicle wiper actuating assembly including a ball joint has been described above, the vehicle wiper actuating assembly and/or the ball joints are not limited to the working example described above, but various design alterations may be carried out without departing from the vehicle wiper actuating assembly and/or ball joint as set forth in the claims.

I claim:

1. A socket assembly configured to receive and retain a ball stud, the socket assembly comprising a socket housing and an elastic retaining element,
the socket housing including
a first end,
a sidewall that surrounds a periphery of the first end, and
a second end opposed to the first end, the second end being open and defined by a free edge of the sidewall,
wherein
an inner surface of the sidewall has a spherical contour that has a center and is dimensioned to receive and retain a ball portion of a ball stud therein,
an outer surface of the sidewall includes
a circumferentially extending first groove that resides in a plane, and the plane is parallel to the first end and includes the center of the spherical contour, and
a circumferentially extending second groove that is located between the plane and the second end, the second groove being parallel to the first groove, and
wherein the retaining element is disposed in the second groove.

2. The socket assembly of claim 1, wherein
the sidewall extends below the plane to an extent that a line passing through the center and intersecting the free edge of the sidewall forms an angle relative to the plane, and the angle is greater than 30 degrees.

3. The socket assembly of claim 1, wherein the socket housing includes a slit formed in the sidewall, the slit passing through a thickness of the sidewall and opening at the second end.

4. The socket assembly of claim 3, wherein the slit extends in a direction perpendicular to the plane.

5. The socket assembly of claim 3, wherein the slit intersects the second groove.

6. The socket assembly of claim 1, wherein the retaining element is a C clip.

7. The socket assembly of claim 1, wherein the retaining element is a discontinuous flat washer.

8. A ball joint comprising a socket assembly and a ball stud, wherein
the ball stud includes
a cylindrical shank, and
a ball portion disposed on one end of the shank, the ball portion including a major diameter defined by a line that is perpendicular to a longitudinal axis of the shank and intersects the spherical element at a location of maximum diameter;
the socket assembly is configured to receive and retain the ball portion, the socket assembly including a socket housing and an elastic retaining element,
the socket housing including
a first end,
a sidewall that surrounds a periphery of the first end, and
a second end opposed to the first end, the second end being open and defined by a free edge of the sidewall, and
wherein
an inner surface of the sidewall has a spherical contour that has a center and is dimensioned to receive and retain a ball portion of a ball stud therein,
an outer surface of the sidewall includes
a circumferentially extending first groove that resides in a plane, and the plane is parallel to the first end and includes the center of the spherical contour, and
a circumferentially extending second groove that is located between the plane and the second end, the second groove being parallel to the first groove, and
wherein the retaining element is disposed in the second groove.

9. The ball joint of claim 8, wherein
the sidewall extends below the plane to an extent that a line passing through the center and intersecting the free edge of the sidewall forms an angle relative to the plane, and the angle is greater than 30 degrees.

10. The ball joint of claim 8, wherein the socket housing includes a slit formed in the sidewall, the slit passing through a thickness of the sidewall and opening at the second end.

11. A link assembly, comprising
a link having a first end including a first opening;
a socket assembly disposed in the first opening, the socket assembly including a socket housing and an elastic retaining element,
the socket housing including
a first end,
a sidewall that surrounds a periphery of the first end, and
a second end opposed to the first end, the second end being open and defined by a free edge of the sidewall,
wherein
an inner surface of the sidewall has a spherical contour that has a center and is dimensioned to receive and retain a ball portion of a ball stud therein,
an outer surface of the sidewall includes
a circumferentially extending first groove that resides in a plane, and the plane is parallel to the first end and includes the center of the spherical contour, and
a circumferentially extending second groove that is located between the plane and the second end, the second groove being parallel to the first groove, and
wherein the retaining element is disposed in the second groove.

12. The link arm assembly of claim 11, wherein
the sidewall extends below the plane to an extent that a line passing through the center and intersecting the free edge of the sidewall forms an angle relative to the plane, and the angle is greater than 30 degrees.

13. The link arm assembly of claim 11, wherein the socket housing includes a slit formed in the sidewall, the slit passing through a thickness of the sidewall and opening at the second end.

14. A wiper actuating assembly configured to actuate a wiper arm, the assembly comprising
an actuator;
a linkage that connects the actuator to the wiper arm, the linkage including
a link having a first end including a first opening;
a socket assembly disposed in the first opening, the socket assembly comprising a socket housing and a spring element,
the socket housing including
a first end,
a sidewall that surrounds a periphery of the first end, and
a second end opposed to the first end, the second end being open and defined by a free edge of the sidewall,
wherein
an inner surface of the sidewall has a spherical contour that has a center and is dimensioned to receive and retain a ball portion of a ball stud therein,
an outer surface of the sidewall includes
a circumferentially extending first groove that resides in a plane, and the plane is parallel to the first end and includes the center of the spherical contour, and
a circumferentially extending second groove that is located between the plane and the second end, the second groove being parallel to the first groove, and
wherein the retaining element is disposed in the second groove.

15. The wiper actuating assembly of claim 14, wherein
the sidewall extends below the plane to an extent that a line passing through the center and intersecting the free edge of the sidewall forms an angle relative to the plane, and the angle is greater than 30 degrees.

16. The wiper actuating assembly of claim 14, wherein the socket housing includes a slit formed in the sidewall, the slit passing through a thickness of the sidewall and opening at the second end.

17. The wiper actuating assembly of claim 16, wherein the slit extends in a direction perpendicular to the plane.

18. The wiper actuating assembly of claim 16, wherein the slit intersects the second groove.

19. The wiper actuating assembly of claim 14, wherein the retaining element is a C clip.

20. The wiper actuating assembly of claim 14, wherein the retaining element is a discontinuous flat washer.
